(19) United States
(12) Patent Application Publication
(10) Pub. No.: US 2018/0184640 A1
(43) Pub. Date: Jul. 5, 2018

(54) CRAWFISH AQUACULTURE TRAP AND FLUSH SYSTEM AND METHOD

(71) Applicant: Gary Miller, Basile, LA (US)

(72) Inventor: Gary Miller, Basile, LA (US)

(21) Appl. No.: 15/396,142

(22) Filed: Dec. 30, 2016

(51) Int. Cl. A01M 23/02; A01K 61/59; A01K 63/00

(52) U.S. Cl. CPC A01M 23/02; A01K 63/00; A01K 61/59

(57) ABSTRACT

A crawfish aquaculture trap and flush system and method of crawfish farming on flooded fields, providing multiple baited crawfish traps connected via a pipe system through which crawfish are flushed to a collection hopper. Crawfish traps having sealable entryways and a sealable baiting riser allow entry of crawfish into the traps, attracted by bait, during an unpressurized phase, and subsequent application of water pressure at a pump end of the system, which seals the entryways and baiting riser and flushes trapped crawfish through the piping and other traps toward a collection hopper at a collection end of the system. This crawfish aquaculture trap and flush system and method does not require manual harvesting, does not require a boat and boat operator, and does not cause boat-related damage to the fields.

### BACKGROUND OF THE INVENTION

This invention provides a crawfish aquaculture trap and flush system and method of crawfish farming on a flooded field.

Crawfish, also called crayfish, specifically the red swamp crawfish, Procambarus clarkii, and the white river crawfish, Procambarus zonangulus, are farmed commercially in fields enclosed by levees, dikes, or berms which retain water and allow the fields to be alternately flooded and drained. Rice grows in the same type of floodable-drainable fields, during a different season. Rice stubble left on the fields after harvesting makes good forage for crawfish. Therefore, much crawfish aquaculture is practiced in rotation with rice farming. But the present method of crawfish aquaculture causes recurring damage to the rice fields which has to be remediated every year before rice-farming season.

The current method of harvesting crawfish consists of wired traps deployed and retrieved by an operator manually via a boat. The crawfish boat is driven by a gasoline engine and hydraulic motor that propels a 30″ diameter steel wheel. The wheel, which is very similar to a paddle wheel boat, stays in constant contact with the ground, while the remainder of the boat floats on the water. The wheel continuously creates ruts or boat rows while operating pushing the boat during the crawfish harvest season of January through June. After the harvest, pond water is drained off to allow mature crawfish to burrow while at the same time allowing the ponds to dry so that boat rows or ruts can be repaired. Crawfish boats cost in ranges from $6000 used to $20,000 new. Ground repair generally cost between $25 to $100 per acre, depending on the severity of the ruts and the equipment available to remediate the ground.

The current method of harvesting crawfish consists of one boat operator per boat. One boat typically covers 150 to 200 acres per day, usually with the same operator. The crawfish boat operator will typically handle 1500 to 2000 traps per day. The labor cost for these operators generally run between $10-12/hour. Crawfish boat operators typically log 70 hours per 6 day week, so weekly labor cost could run $840 per operator.

Typical crawfish ponds have ten traps per acre, and the ponds may be as large as 100 acres, or larger. It typically takes about six hours to run and re-bait such a crawfish pond.

U.S. Pat. No. 4,718,192 issued Jan. 12, 1988 to Robert L. Louk for a “Hydromechanical Bait Trap.” In the Louk trap, a conduit assembly is provided that includes a “field” of prearranged conduit sections, or runs, and also includes inlet and outlet ends. The conduit assembly, pictured below, is designed to be supported adjacent the bottom of a shallow pond, and includes a partially submerged mesh sump into whose lower portion the inlet end of the conduit assembly opens. The outlet end of the conduit assembly discharges downwardly into the sump, the sump being adapted to received ground or finely cut-up bait. A pump is serially connected in the inlet end, and the conduit sections comprising the “field” include a plurality of lateral branches opening into the runs and mounted therefrom for annular displacement thereabout between lower generally horizontal positions, and upstanding upright positions projecting above the pond water level. The free ends of the lateral branches include marine life trap structures, and structure is provided for simultaneously raising and lowering the lateral branches.

U.S. Pat. No. 5,412,808, issued to Aubrey J. Dupree et al. on Sep. 1, 1992, covers a “Pivotable Crayfish Trap.” The invention pertains to the remote harvesting of crawfish by trapping them within a trap submerged in water, and then, when harvesting is desired, applying a counterweight for pivoting the trap so that the trapped crawfish are passed to a line for flushing the crawfish to a collection tank. The operation is accomplished remotely from the harvester, and more than one harvester can be connected to the collection tank. The trap includes (1) an enlongated harvesting member pivotally mounted upon a support member between opposing end regions of the harvesting member; (2) trap means secured to one end region of the harvesting member for trapping aquatic life, with the trap means comprising a conically-shaped wire mesh trap having a funnel means at one end with an opening therein through which the aquatic life may pass; (3) counterweight means secured to the opposite end region of the harvesting member for selectively applying a counterweight to, and removing a counterweight from, the opposite end region of the harvesting member, so as to selectively pivot the trap means about the said support member between a first harvesting position and a second trap-emptying position; (4) collecting means in communication with the trap means for collecting the trapped aquatic life when the counterweight is applied to the opposite end region of the harvesting member, thereby pivoting the trap means from its first to its second position; and (5) means for selectively controlling the application and removal of the counterweight.

U.S. Pat. No. 4,831,773 was issued on May 23, 1989 to William C. Rostrom for a “Crustacean Harvesting Method and System.” The Rostrom patent covers a method and apparatus for harvesting crustaceans in a shallow body of water, using submerged traps in which crustaceans are trapped. The traps are connected into a piping system that is periodically flushed with water to wash the trapped crustaceans to a suitable receiver. The traps have valves that may be periodically shaken to loosen any crustaceans caught in the valves. Means are also provided to aerate the piping system and body of water. The trapping, flushing, and aerating steps may be repeatedly carried while the apparatus is maintained in a stationary position in the body of water.

U.S. Pat. No. 4,858,363, issued to John S. Smith on Aug. 22, 1989, covers a “Crayfish Harvester.” The patent covers an apparatus for harvesting crawfish and similar crustaceans from ponds, utilizing a hollow tube placed in the pond. The tube is provided with openings sized to allow crawfish to enter the hollow tube, where they are then pushed through the tube by the action of a plug being moved through the tube. Specifically, the apparatus includes (1) a hollow tube positioned adjacent to the bottom of a body of water, with the tube having a series of openings in its exterior wall surface connecting to the hollow passageway of the tube, where the openings have a particular shape and are positioned to permit crawfish to past through the openings and into the passageway; (2) a plug means positioned in the passageway, where the plug means have an outer perimeter area shaped to be adjacent to the inner wall surface of the tube; and (3) a second means attached to the plug means, which moves the plug means through the passageway.

U.S. Pat. No. 4,702,676 was issued to Alan P. Westfall and Robert J. Roe on Oct. 27, 1987 for a “Liquid Driven Pump or Propulsive Apparatus.” The apparatus relates to a jet pump or apparatus that displaces a main fluid by a pressurized driving liquid. The apparatus has a duct to receive the main fluid, and a driving liquid manifold cooperating with the duct to receive the pressurized driving liquid. First and second sets of inwardly facing jet nozzles are disposed adjacent a transverse plane of the duct, and penetrate the duct side wall to pass the driving liquid into the duct at a mixing portion of the duct having a constant cross-sectional area. The first and second sets of jet nozzles are inclined at angles to the duct axis so that the first nozzles are inclined at a greater angle than the second nozzles. Efficiency of the pump is improved by admitting pressurized gas into the duct and providing the pump with a diverging outlet portion to act as a diffuser.

U.S. Pat. No. 4,554,759, invented by Robert J. Edling et al. and issued to Research Corporation on Nov. 26, 1985, covers a “Method and Means for Harvesting Crayfish.” The patent discloses a method and apparatus for harvesting crawfish in a shallow aquatic bed. A plurality of one-way traps is aligned in a linear array and supported by a frame that extends above the water level. The traps are lowered into the water for a set time of five minutes to two hours, and then raised to discharge the collected crawfish into a collection hopper. While the traps are out of the water, the linear array is advanced three to twelve meters along an axis substantially perpendicular to the axis of the array. The crawfish are conveyed from the collection hoppers to a single storage tank by a water sluice conveyor. The trap set and discharge cycle is repeated until the harvester has traversed the aquatic bed.

U.S. Pat. No. 3,440,752 was issued on Apr. 29, 1969 to James H. Minter for a “Trawl Net System.” The patent discloses a trawl net system for continuously gathering sea life for use with a boat. The system has a trawl net having a junction box located at the trailing end thereof, a pumping tube connected between the junction box and the boat for conveying seat life to the boat, and pump means for facilitating the conveyance of the seat life. The junction box is provided with a grill that only allows certain sizes of sea life to pass therethrough to the pumping tube. Undesired sea life may escape through a resilient gate, or are ejected from the junction box by a wiper engaging the grill. Control of the apparatus may be effected from the boat by remote control.

U.S. Pat. No. 2,663,117, invented by Lothar A. Ederer and issued to Keal Products Inc. on Dec. 22, 1953, covers a “Fish Trapping Apparatus.” The invention covers an apparatus for trapping eels, sea lampreys, fish, and other marine life, and was invented to provide a simple and durable mechanism for trapping such creatures as they move in the waters of streams. The device includes (1) a main net; (2) means for supporting the net in a body of water in a generally upright position, with its upper margin below the surface of the body of water; and (3) a second separate net member and means for supporting the second separate net member in a generally upright position in the body of water, with its lower margin below the upper margin of the first net, and with the upper margin above the upper margin of the first net.

U.S. Pat. No. 1,462,196 was issued to Cornelis Dros on Jul. 17, 1923 for a “Fishing Apparatus.” The Dros patent covers a fishing apparatus that includes a catching station; a net having a catching compartment; a discharge conduit for the fish, having its inlet end connected to the compartment and its outlet end arranged at the catching station; a pressure fluid supply pipe connected at its outlet end to the compartment; and a pump at the station to which the inlet end of the supply pipe is connected, where the pump acts to deliver pressure fluid through the pipe into the compartment, forcing the fish therein into and through the conduit, and to discharge them at the station. The Dros patent also provides for a fishing apparatus featuring (1) a net having a catching compartment; (2) a discharge conduit for the fish leading from the compartment; (3) a valve system for controlling the entrance of fish and sea water into the compartment, and the escape of the sea water from the compartment, where the valve system opens automatically under the external pressure of the sea water; and (4) means for supplying pressure fluid to the compartment, to force the fish into and through the conduit, and to discharge them at the mouth of the conduit, where the fluid acts to close the valve system on entering the compartment.

U.S. Pat. No. 4,434,572 was issued to William W. Sheldon et al. on Mar. 6, 1984 for “Retrieval of Lobsters and Other Objects,” and covers a method and apparatus for retrieving lobsters or similar objects from the floor of a lobster pound or other shallow water body. An upward flow of water is established in the flexible conduit or passageway, of a size sufficient to accommodate the objects to be lifted. This flow is accomplished by a low-pressure air lift particularly suited for non-traumatic handling of lobsters. Objects to be lifted are drawn into the upward flow as the flexible conduit is moved over the bottom. As objects rise to the surface, they are guided or diverted by a transfer guide chamber or coupling onto a conveyor, which carries the objects onto a deck or support platform floating above the water surface. The transfer chamber and conveyor shed water away from the lobsters or other objects. The transfer guide chamber, conveyor, and a pivotable boom for supporting the flexible conduit in an “S” configuration are attached to a deck or support platform floating above the surface. The entire rig moves throughout the area of the lobster pound or other water body for recovering lobsters at any location.

### SUMMARY OF THE INVENTION

This invention provides a crawfish aquaculture trap and flush system and method of crawfish farming on flooded fields, providing multiple baited crawfish traps connected via a pipe system through which crawfish are flushed to a collection hopper. This crawfish aquaculture trap and flush system and method does not require manual harvesting, does not require a boat and boat operator, and does not cause boat-related damage to the fields.

### BRIEF DESCRIPTION OF DRAWINGS

Reference will now be made to the drawings, wherein like parts are designated by like numerals, and wherein:

FIG. 1 is a schematic perspective view of the crawfish aquaculture trap and flush system and method of the present invention in use;

FIG. 2 is a perspective view of the crawfish aquaculture trap and flush system and method of the present invention under conditions of no pressurized flow of water;

FIG. 3 is a perspective view of the crawfish aquaculture trap and flush system and method of the present invention under conditions of a pressurized flow of water;

FIG. 4 is a perspective section view of the crawfish aquaculture trap and flush system and method of the present invention under conditions of no pressurized flow of water;

FIG. 5 is a perspective section view of the crawfish aquaculture trap and flush system and method of the present invention under conditions of a pressurized flow of water;

FIG. 6 is a section view of he crawfish aquaculture trap and flush system and method of the present invention under conditions of no pressurized flow of water;

FIG. 7 is a section view of the crawfish aquaculture trap and flush system and method of the present invention under conditions of a pressurized flow of water;

FIG. 8 is a partially cutaway top view of the crawfish aquaculture trap and flush system and method of the present invention under conditions of no pressurized flow of water;

FIG. 9 is a partially cutaway top view of the crawfish aquaculture trap and flush system and method of the present invention under conditions of a pressurized flow of water;

FIG. 10 is a schematic view of a first embodiment of the crawfish aquaculture trap and flush system and method of the present invention;

FIG. 11 is a schematic view of a second embodiment of the crawfish aquaculture trap and flush system and method of the present invention;

FIG. 12 is a schematic view of a third embodiment of the crawfish aquaculture trap and flush system and method of the present invention.

### DETAILED DESCRIPTION OF THE INVENTION

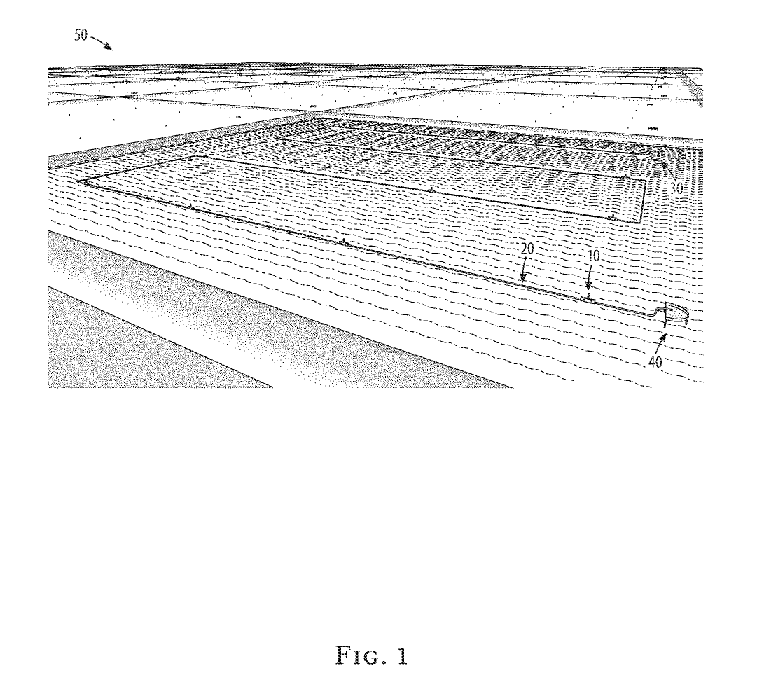

Referring to FIG. 1 and all of the figures generally, the crawfish aquaculture trap and flush system 50 of the invention is shown. The crawfish aquaculture trap and flush system 50 provides several trap boxes 10 connected by pipe segments 20, with a water pump 30 supplying water under pressure to the system on one end, and a collection hopper 40 at the opposite end. A serial arrangement of trap boxes 10 and pipe segments 20 is illustrated. A parallel arrangement, using manifolds, is also possible, as is a mixed serial and parallel arrangement.

The trap boxes 10 are mostly submerged under the approximately one foot of water covering the field, with only the top portion of a baiting riser being above the water line. The water pump 30 as illustrated is above the water line, although a submersible pump can also be used. The collection hopper 40 is mostly above the water line, with legs or other support extending underwater to the ground.

The water pump 30 can draw water directly from the flooded field, as illustrated, or can draw water from an outside supply if it is desired to add water and raise the water level on the field. The collection hopper 40 can have perforations for drainage of water, or can be unperforated, since excess water will spill over the sides and back into the flooded field. Crawfish in the several trap boxes 10 will be flushed out and through the pipe segments 20 by the flow of water under pressure from the water pump 30, ultimately to the collection hopper 40 where they will be retained, while the water returns to the flooded field.

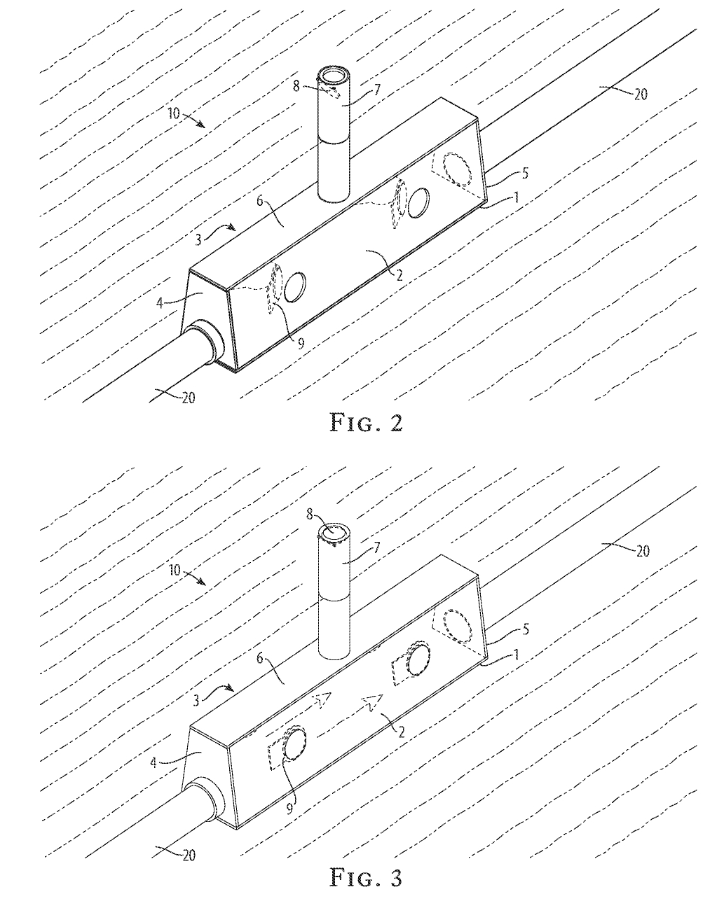

Referring to FIG. 2, each trap box 10 has a trap bottom 1, a trap-starboard slanting side 2, a trap-port slanting side 3, an in-port side 4, and out-port side 5, and a trap top 6, through which extends a baiting riser 7. The trap-starboard side 2 and trap-port side 3 have openings of an appropriate size to allow the entry of crawfish into the trap box 10. The baiting riser 7 extends up above the waterline, and provides for the supply and re-supply of bait to the trap box 10. Portions of the baiting riser 7 can be provided with perforations in order to better allow crawfish to detect the presence of the bait.

Referring additionally to FIG. 3, water flows from a pipe segment 20 into the in-port side 4, through the trap box 10, and out of the out-port side 5 into another pipe segment 20. A hinged riser flap seal 8 is provided in or on the baiting riser 7 to allow bait to be dropped down the riser, but to prevent the pressurized flow of water from escaping through the riser. Hinged flap seals 9 are provided at each opening in the slanting sides 2, 3. The hinges are placed on the in-port side of each opening. Because of the slant of the slanting sides 2, 3, the flap seals 9 will fall away from, or be easily pushed away from, the openings, when there is no pressure differential between the interior and exterior of the trap box 10. Therefore the trap-starboard and trap-port sides 2, 3 will be open an allow the entry of crawfish into the trap box 10. When water under pressure flows through the trap box 10, the flow of water will push the flap seals 9 toward a closed position, and the pressure differential will hold the seals closed, preventing the escape or ejection of crawfish through any opening other than the opening in the out-port side 5 of the trap box 10.

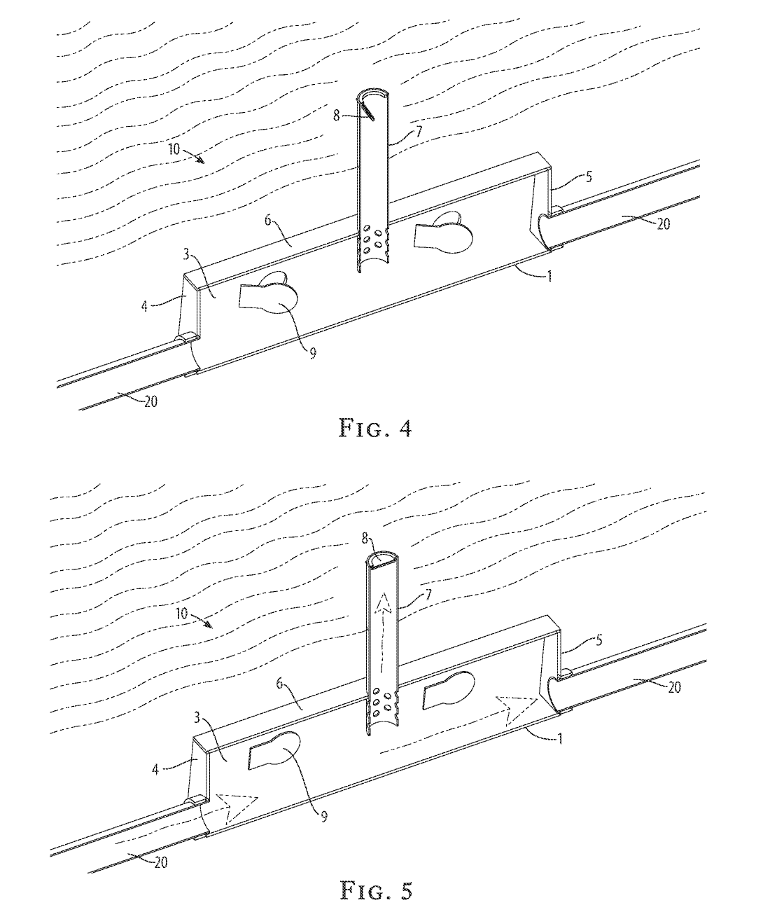

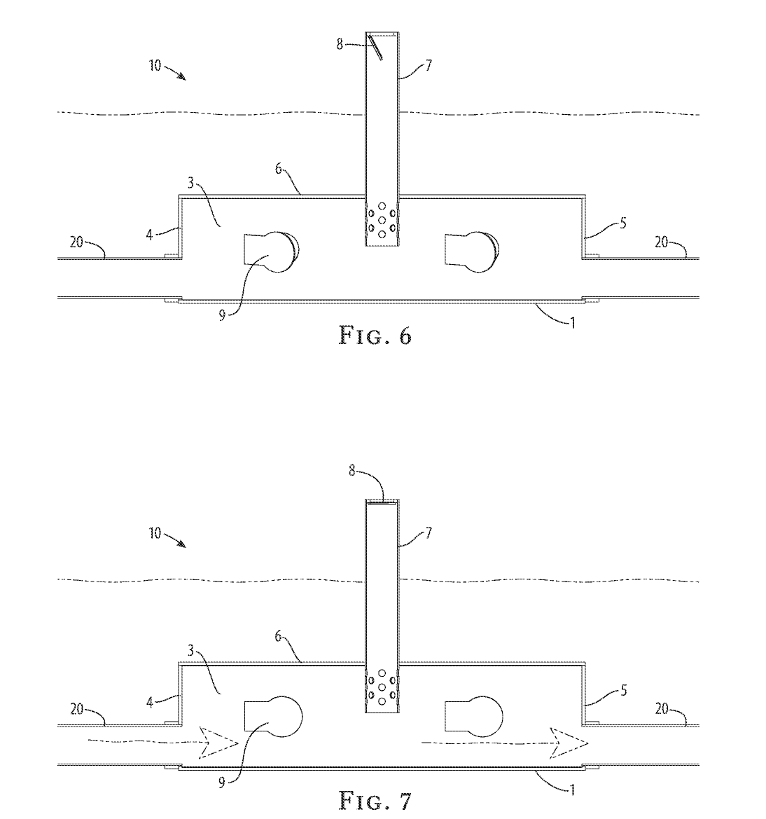

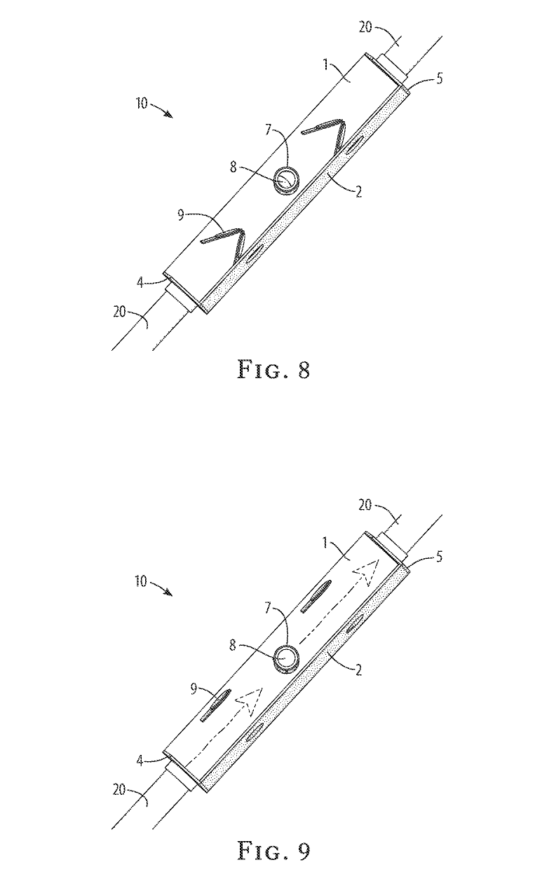

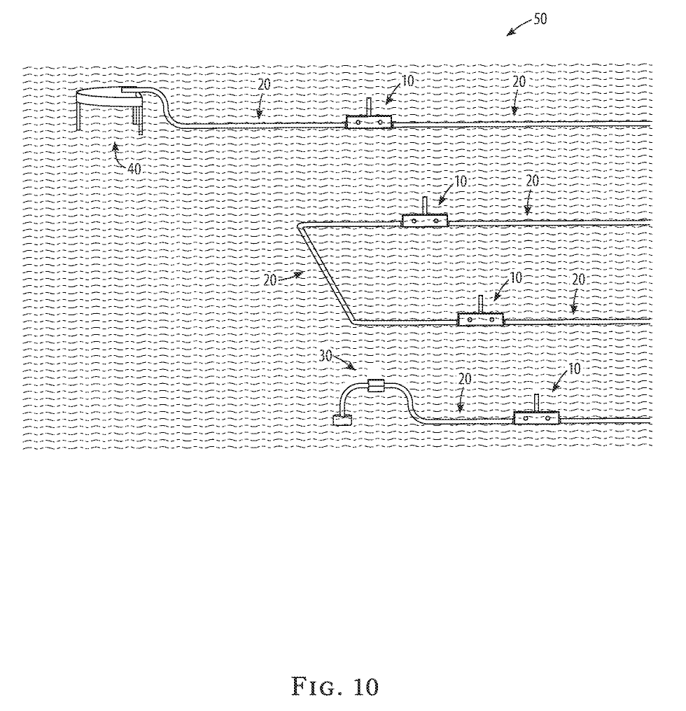

FIGS. 4 through 10 illustrate these operating principles in section, cutaway, and schematic views.

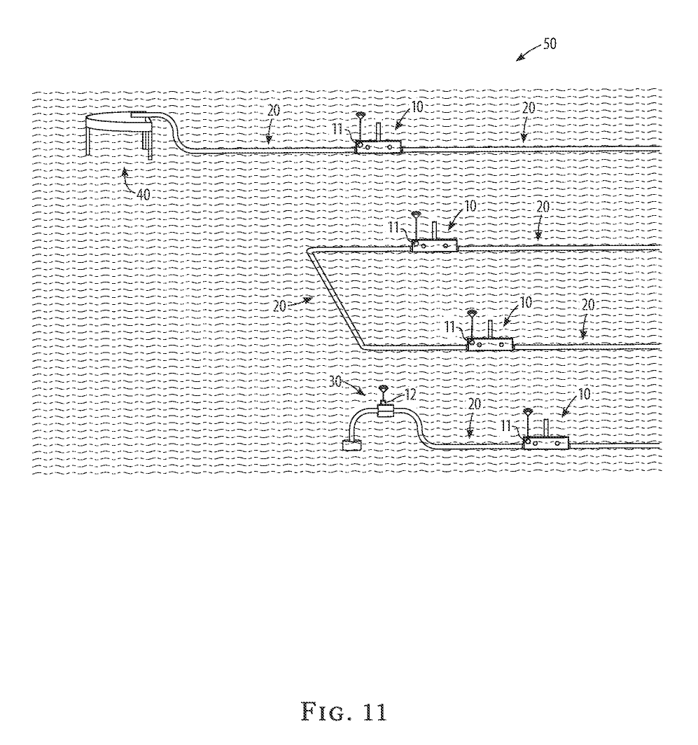

Referring to FIG. 11, a second embodiment of the crawfish aquaculture trap and flush system 50 additionally provides a trap sensor 11 for each trap box 10. The trap sensor 11 senses the presence or absence of crawfish inside the trap box 10. This sensing can be done by a variety of methods known in the art, such as passive motion detection or passive infrared detection, or by active methods so long as any emitted signal does not repel the crawfish. The trap sensors 11 transmit signals to a pump controller 12 which activates the water pump 30 when a threshold number of trap sensors 11 indicate the presence of crawfish.

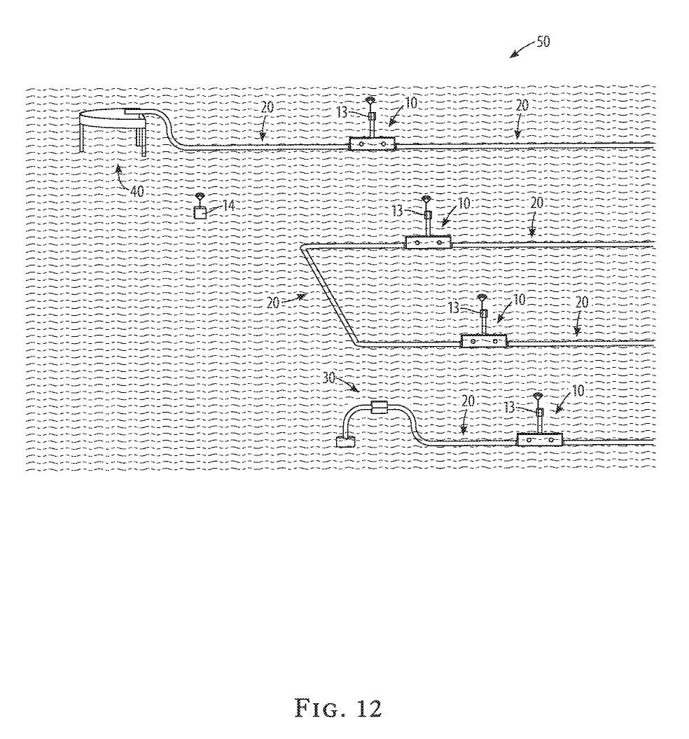

Referring to FIG. 12, a third embodiment of the crawfish aquaculture trap and flush system 50 additionally provides a bait feeder 13 on the baiting riser 7 of each trap box 10. The bait feeder 13 contains a store of bait, portions of which can be released into the baiting riser 7 upon activation of the bait feeder 13. The bait feeder 13 also provides the ability to transmit and receive signals, and can be instructed to release bait, and optionally can report an out-of-bait condition or a percent-empty status. A feeder controller 14 transmits instruction signals to the bait feeders 13, either to individual bait feeders 13 or as a broadcast, general instruction. Optionally, the feeder controller 14 can also receive, analyze, and report out-of-bait or percent-empty status for each trap box 10.

With appropriate modifications, this crawfish aquaculture trap and flush system 50 can be applied to marine-animal aquaculture more generally, in farmed and in wild environments.

Many other changes and modifications can be made in the system and method of the present invention without departing from the spirit thereof. I therefore pray that my rights to the present invention be limited only by the scope of the appended claims.

I claim:

1. A crawfish aquaculture trap and flush system of crawfish farming on a flooded field, the crawfish aquaculture trap and flush system comprising:
(i) a plurality of trap boxes arrayed upon the flooded field, each adapted to accept a flow of water from an in-port end to an out-port end, the trap box comprising:
(a) a trap bottom;
(b) a trap top;
(c) a trap-starboard slanting side having at least one opening for entry of crawfish;
(d) a trap-port slanting side having at least one opening for entry of crawfish;
(e) an in-port side having an opening adapted for an inflow of water;
(f) an out-port side having an opening adapted for an outflow of water;
(g) a plurality of flap seals arrayed upon inner surfaces of said trap-starboard slanting side and said trap-port slanting side at each opening for entry of crawfish, each said flap seal having a flap hinge, each said flap seal being adapted to fall into an open position in the absence of a pressure differential within and without said trap box, and move into a closed position in the presence of higher pressure within said trap box;
(h) a baiting riser affixed through an opening in said trap top;
(i) a riser flap seal having a flap hinge, adapted to fall into an open position in the absence of a pressure differential within and without said trap box, and move into a closed position in the presence of higher pressure within said trap box;
(ii) a water pump adapted to supply a flow of water under pressure;
(iii) a collection hopper adapted to collect crawfish from a flow of water;
(iv) a plurality of pipe segments arrayed so as to distribute water from said water pump to the in-port side of each said trap box, through the out-port side of each said trap box to said collection hopper;
where, in use, with no pressure supplied by said water pump, each said trap box is supplied with bait through said baiting riser, crawfish enter said trap box through the openings in said trap-starboard slanting side and said trap-port slanting side, water pressure is supplied by said water pump, said flap seals and riser flap seal move into a closed position, the flow of water under pressure flushes the crawfish out of said trap box and through said pipe segments toward said collection hopper, which collects the crawfish.

2. The crawfish aquaculture trap and flush system of claim 1, where said pipe segments are arrayed in series, so as to connect said water pump to the in-port side of a first said trap box, and connect the out-port side of said first trap box to the in-port side of a second said trap box, repeating until connecting the out-port side of a last said trap box to said collection hopper.

3. The crawfish aquaculture trap and flush system of claim 1, where said pipe segments are arrayed in parallel as manifolds.

4. The crawfish aquaculture trap and flush system of claim 1, where said water pump is further adapted to draw water from the flooded field.

5. The crawfish aquaculture trap and flush system of claim 1, where said water pump is further adapted to draw water from a supply outside the flooded field.

6. The crawfish aquaculture trap and flush system of claim 1, further comprising:
(i) a plurality of trap sensors, each adapted to sense the presence of crawfish in a given said trap box, and transmit a corresponding signal; and
(ii) a pump controller adapted to collect signals from said trap sensors and to activate or deactivate said water pump as appropriate.

7. The crawfish aquaculture trap and flush system of claim 1, further comprising:
(i) a plurality of bait feeders, each adapted to receive transmitted signals, and to hold bait and to release bait into said baiting riser upon receipt of a corresponding signal; and
(ii) a feeder controller adapted to transmit signals to said bait feeders as appropriate.

8. The crawfish aquaculture trap and flush system of claim 1, further comprising:
(i) a plurality of bait feeders, each adapted to receive and transmit, to hold bait and to release bait into said baiting riser upon receipt of a corresponding signal, and to transmit signals corresponding to the supply of bait remaining within each said bait feeder; and
(ii) a feeder controller adapted to transmit and receive signals to and from said bait feeders.

9. The crawfish aquaculture trap and flush system of claim 1, further comprising:
(i) a plurality of bait feeders, each adapted to receive and transmit, to hold bait and to release bait into said baiting riser upon receipt of a corresponding signal, and to transmit signals corresponding to the supply of bait remaining within each said bait feeder; and
(ii) a feeder controller adapted to transmit and receive signals to and from said bait feeders, and to generate reports indicating the bait supply of each said bait feeder.

10. The crawfish aquaculture trap and flush system of claim 1, further comprising:
(i) a plurality of trap sensors, each adapted to sense the presence of crawfish in a given said trap box, and transmit a corresponding signal;
(ii) a plurality of bait feeders, each adapted to receive and transmit, to hold bait and to release bait into said baiting riser upon receipt of a corresponding signal, and to transmit signals corresponding to the supply of bait remaining within each said bait feeder;
(iii) a pump controller adapted to collect signals from said trap sensors and to activate or deactivate said water pump; and
(iv) a feeder controller adapted to transmit and receive signals to and from said bait feeders, to receive signals from said trap sensors, and to transmit and receive signals to and from said pump controller;
where said pump controller and said feeder controller provide information each to the other, and avoid activation of said water pump too soon after a release of bait, and avoid release of bait too soon before an anticipated activation of said water pump.

11. A crawfish aquaculture trap and flush method of crawfish farming on a flooded field, the crawfish aquaculture trap and flush method:
(i) providing a plurality of trap boxes arrayed upon the flooded field, each adapted to accept a flow of water from an in-port end to an out-port end, the trap box comprising:
(a) a trap bottom;
(b) a trap top;
(c) a trap-starboard slanting side having at least one opening for entry of crawfish;
(d) a trap-port slanting side having at least one opening for entry of crawfish;
(e) an in-port side having an opening adapted for an inflow of water;
(f) an out-port side having an opening adapted for an outflow of water;
(g) a plurality of flap seals arrayed upon inner surfaces of said trap-starboard slanting side and said trap-port slanting side at each opening for entry of crawfish, each said flap seal having a flap hinge, each said flap seal being adapted to fall into an open position in the absence of a pressure differential within and without said trap box, and move into a closed position in the presence of higher pressure within said trap box;
(h) a baiting riser affixed through an opening in said trap top;
(i) a riser flap seal having a flap hinge, adapted to fall into an open position in the absence of a pressure differential within and without said trap box, and move into a closed position in the presence of higher pressure within said trap box;
(ii) providing a water pump adapted to supply a flow of water under pressure;
(iii) providing a collection hopper adapted to collect crawfish from a flow of water;
(iv) providing a plurality of pipe segments arrayed so as to distribute water from said water pump to the in-port side of each said trap box, through the out-port side of each said trap box to said collection hopper;
where, in use, with no pressure supplied by said water pump, each said trap box is supplied with bait through said baiting riser, crawfish enter said trap box through the openings in said trap-starboard slanting side and said trap-port slanting side, water pressure is supplied by said water pump, said flap seals and riser flap seal move into a closed position, the flow of water under pressure flushes the crawfish out of said trap box and through said pipe segments toward said collection hopper, which collects the crawfish.

12. A marine-animal aquaculture trap and flush system for underwater farming, comprising:
(i) a plurality of trap boxes arrayed under water, each adapted to accept a flow of water from an in-port end to an out-port end, the trap box comprising:
(a) a trap bottom;
(b) a trap top;
(c) a trap-starboard slanting side having at least one opening for entry of marine animals;
(d) a trap-port slanting side having at least one opening for entry of marine animals;
(e) an in-port side having an opening adapted for an inflow of water;
(f) an out-port side having an opening adapted for an outflow of water;
(g) a plurality of flap seals arrayed upon inner surfaces of said trap-starboard slanting side and said trap-port slanting side at each opening for entry of marine animals, each said flap seal having a flap hinge, each said flap seal being adapted to fall into an open position in the absence of a pressure differential within and without said trap box, and move into a closed position in the presence of higher pressure within said trap box;
(h) a baiting riser affixed through an opening in said trap top;
(i) a riser flap seal having a flap hinge, adapted to fall into an open position in the absence of a pressure differential within and without said trap box, and move into a closed position in the presence of higher pressure within said trap box;
(j) a water pump adapted to supply a flow of water under pressure;
(k) a collection hopper adapted to collect marine animals from a flow of water;
(l) a plurality of pipe segments arrayed so as to distribute water from said water pump to the in-port side of each said trap box, through the out-port side of each said trap box to said collection hopper;
where, in use, with no pressure supplied by said water pump, each said trap box is supplied with bait through said baiting riser, marine animals enter said trap box through the openings in said trap-starboard slanting side and said trap-port slanting side, water pressure is supplied by said water pump, said flap seals and riser flap seal move into a closed position, the flow of water under pressure flushes the marine animals out of said trap box and through said pipe segments toward said collection hopper, which collects the marine animals.

13. The marine-animal aquaculture trap and flush system of claim 12, where said pipe segments are arrayed in parallel as manifolds.

14. The marine-animal aquaculture trap and flush system of claim 12, where said water pump is further adapted to draw water from the immediate environment.

15. The marine-animal aquaculture trap and flush system of claim 12, where said water pump is further adapted to draw water from a supply outside the immediate environment.

16. The marine-animal aquaculture trap and flush system of claim 12, further comprising:
(i) a plurality of trap sensors, each adapted to sense the presence of marine animals in a given said trap box, and transmit a corresponding signal; and
(ii) a pump controller adapted to collect signals from said trap sensors and to activate or deactivate said water pump as appropriate.

17. The marine-animal aquaculture trap and flush system of claim 12, further comprising:
(i) a plurality of bait feeders, each adapted to receive transmitted signals, and to hold bait and to release bait into said baiting riser upon receipt of a corresponding signal; and
(ii) a feeder controller adapted to transmit signals to said bait feeders as appropriate.

18. The marine-animal aquaculture trap and flush system of claim 12, further comprising:
(i) a plurality of bait feeders, each adapted to receive and transmit, to hold bait and to release bait into said baiting riser upon receipt of a corresponding signal, and to transmit signals corresponding to the supply of bait remaining within each said bait feeder; and
(ii) a feeder controller adapted to transmit and receive signals to and from said bait feeders.

19. The marine-animal aquaculture trap and flush system of claim 12, further comprising:
(i) a plurality of bait feeders, each adapted to receive and transmit, to hold bait and to release bait into said baiting riser upon receipt of a corresponding signal, and to transmit signals corresponding to the supply of bait remaining within each said bait feeder; and
(ii) a feeder controller adapted to transmit and receive signals to and from said bait feeders, and to generate reports indicating the bait supply of each said bait feeder.

20. The marine-animal aquaculture trap and flush system of claim 12, further comprising:
(i) a plurality of trap sensors, each adapted to sense the presence of crawfish in a given said trap box, and transmit a corresponding signal;
(ii) a plurality of bait feeders, each adapted to receive and transmit, to hold bait and to release bait into said baiting riser upon receipt of a corresponding signal, and to transmit signals corresponding to the supply of bait remaining within each said bait feeder;
(iii) a pump controller adapted to collect signals from said trap sensors and to activate or deactivate said water pump;
(iv) a feeder controller adapted to transmit and receive signals to and from said bait feeders, to receive signals from said trap sensors, and to transmit and receive signals to and from said pump controller;
where said pump controller and said feeder controller provide information each to the other, and avoid activation of said water pump too soon after a release of bait, and avoid release of bait too soon before an anticipated activation of said water pump.
